(19) United States
(12) Patent Application Publication
(10) Pub. No.: US 2023/0212062 A1
(43) Pub. Date: Jul. 6, 2023

(54) CRYSTALLIZED GLASS, HIGH FREQUENCY SUBSTRATE, ANTENNA FOR LIQUID CRYSTALS, AND METHOD FOR PRODUCING CRYSTALLIZED GLASS

(71) Applicant: AGC Inc., Tokyo (JP)

(72) Inventors: Kazuki KANEHARA, Tokyo (JP); Yutaka KUROIWA, Tokyo (JP)

(73) Assignee: AGC Inc., Tokyo (JP)

(21) Appl. No.: 18/184,114

(22) Filed: Mar. 15, 2023

Related U.S. Application Data
(63) Continuation of application No. PCT/JP2021/034010, filed on Sep. 15, 2021.

(30) Foreign Application Priority Data
Sep. 18, 2020 (JP) 2020-157712

(51) Int. Cl. C03C 10/00; C03C 3/097; G02F 1/13; C03C 3/085

(52) U.S. Cl. CPC C03C 10/0045; C03C 3/097; G02F 1/13; C03C 3/085; C03C 2214/20; C03C 2203/52

(57) ABSTRACT

The present invention relates to a crystallized glass including: at least one crystal of indialite and cordierite, in which the crystallized glass has a total amount of the crystal is 40 mass % or more of the crystallized glass, and the crystal comprises at least one of a vacancy and a different element at an Al site.

### CROSS-REFERENCE TO RELATED APPLICATIONS

This is a continuation of International Application No. PCT/JP2021/034010 filed on Sep. 15, 2021, and claims priority from Japanese Patent Application No. 2020-157712 filed on Sep. 18, 2020, the entire content of which is incorporated herein by reference.

### TECHNICAL FIELD

The present disclosure relates to a crystallized glass, a high-frequency substrate, a liquid crystal antenna, and a method for producing a crystallized glass.

### BACKGROUND ART

In recent years, wireless transmission using a microwave band or a millimeter wave band has attracted attention as a large-capacity transmission technique. As a signal frequency increases with expansion of a frequency to be used, a dielectric substrate excellent in dielectric characteristics at a high-frequency is required.

Examples of a material of the dielectric substrate include quartz, ceramics, and glass. Here, among the glass, a crystallized glass in which a part of the glass is crystallized can be easily molded and inexpensively produced as compared with quartz or ceramics, and has an advantage that dielectric characteristics can be further improved. Examples of the crystallized glass having excellent dielectric characteristics include a crystallized glass containing crystals of indialite or cordierite, as disclosed in Patent Literature 1.

### CITATION LIST

### Patent Literature

Patent Literature 1: WO 2020/023205

### SUMMARY OF THE INVENTION

### Technical Problem

However, in the case where a ratio of the crystals of indialite and cordierite in the crystallized glass is increased in order to improve the dielectric characteristics, cracking may occur due to a difference in thermal expansion coefficient between a crystal phase and a glass phase.

Accordingly, an object of the present disclosure is to solve the above problems and to provide a crystallized glass in which the cracking is prevented while a large amount of crystals of indialite and cordierite are contained and excellent dielectric characteristics are achieved.

### Solution to Problem

That is, the present disclosure provides a crystallized glass including: at least one crystal of indialite and cordierite,

in which the crystallized glass has a total amount of the crystal of 40 mass % or more of the crystallized glass, and

the crystal includes at least one of a vacancy and a different element at an Al site.

In one aspect of the crystallized glass according to the present disclosure, a total of portions containing at least one of the vacancy and the different element may be 4 atom % or more of the Al sites.

In one aspect of the crystallized glass according to the present disclosure, the crystallized glass may further include:

in terms of mass percentage based on oxides,

45% to 60% of SiO₂;

20% to 35% of Al₂O₃; and

9% to 15% of MgO.

In one aspect of the crystallized glass according to the present disclosure, the crystallized glass may further include: 5% to 15% of TiO₂ in terms of mass percentage based on oxides.

In one aspect of the crystallized glass according to the present disclosure, the crystallized glass may further include: 0.5% to 15% of P₂O₅ in terms of mass percentage based on oxides.

In one aspect of the crystallized glass according to the present disclosure, the crystallized glass may include main surfaces facing each other, the main surface may have an area of 100 cm² to 100000 cm², and the crystallized glass may have a thickness of 0.01 mm to 2 mm.

In one aspect of the crystallized glass according to the present disclosure, a thermal conductivity at 20° C. may be 1.0 W/(m·K) or more.

In one aspect of the crystallized glass according to the present disclosure, a relative dielectric constant at 20° C. and 10 GHz may be 7 or less.

In one aspect of the crystallized glass according to the present disclosure, a dielectric loss tangent at 20° C. and 10 GHz may be 0.003 or less.

In one aspect of the crystallized glass according to the present disclosure, an average thermal expansion coefficient at 50° C. to 350° C. may be 1 ppm/° C. or more.

The present disclosure provides a high-frequency substrate using the crystallized glass.

The present disclosure provides a liquid crystal antenna using the crystallized glass.

The present disclosure provides an amorphous glass including:

in terms of mass percentage based on oxides,

45% to 60% of SiO₂;

20% to 35% of Al₂O₃:

9% to 15% of MgO;

0.5% to 15% of P₂O₅; and

5% to 15% of TiO₂.

The present disclosure provides a method for producing a crystallized glass, the method including:
preparing an amorphous glass including, in terms of mass percentage based on oxides,
45% to 60% of SiO₂,
20% to 35% of Al₂O₃, and
9% to 15% of MgO; and

performing heat treatment on the amorphous glass,

in which in the heat treatment, at least one crystal of indialite and cordierite is precipitated, and at least one of a vacancy and a different element is made to be present at an Al site of the crystal.

In one aspect of the method for producing a crystallized glass according to the present disclosure, the amorphous glass may include,

in terms of mass percentage based on oxides,

0.5% to 15% of P₂O₅, and

5% to 15% of TiO₂.

In one aspect of the method for producing a crystallized glass according to the present disclosure, the amorphous glass may include main surfaces facing each other, the main surface may have an area of 100 cm² to 100000 cm², and the amorphous glass may have a thickness of 0.01 mm to 2 mm.

In one aspect of the method for producing a crystallized glass according to the present disclosure, the heat treatment may include holding the amorphous glass at 960° C. or higher for 0.5 hours or longer.

In one aspect of the method for producing a crystallized glass according to the present disclosure, the heat treatment may include holding in a first temperature range and holding in a second temperature range, the first temperature range may be 760° C. or higher and 960° C. or lower, a holding time in the first temperature range may be 0.5 hours or longer, the second temperature range may be 960° C. or higher and 1350° C. or lower, and a holding time in the second temperature range may be 0.5 hours or longer.

### Advantageous Effects of Invention

According to the present disclosure, by containing 40 mass % or more of at least one crystal of indialite and cordierite, excellent dielectric characteristics are achieved. and at the same time, such a crystal includes at least one of a vacancy and a different element at an Al site, so that a crystallized glass in which cracking due to a difference in thermal expansion coefficient between a crystal phase and a glass phase is prevented and a high-frequency substrate and a liquid crystal antenna using the crystallized glass are obtained.

### BRIEF DESCRIPTION OF DRAWINGS

The FIG. is a diagram schematically showing a temperature change in a two-stage heat treatment.

### DESCRIPTION OF EMBODIMENTS

In the present description, “to” indicating a numerical range is used in the sense of including the numerical values set forth before and after the “to” as a lower limit value and an upper limit value. Unless otherwise specified, “to” in the present specification is used in the same meaning.

In the present specification, a glass composition is expressed in terms of mass percentage based on oxides unless otherwise specified, and mass % is simply expressed as “%”. In the present specification, ratios (such as percentages) based on mass are the same as ratios (such as percentages) based on weight.

In the present specification, “substantially not included” means that a content is less than an impurity level included in the raw materials and the like, that is, it is not intentionally included. Specifically, the content is, for example, less than 0.1 mass %.

In the present specification, the term “crystallized glass” refers to a glass in which a crystal is precipitated in glass. In the present application, the term “crystallized glass” refers to a glass in which a diffraction peak indicating the crystal is recognized by an X-ray diffraction (XRD) method. In X-ray diffraction measurement, for example, a range of 20=10° to 80° is measured by using a CuKα ray, and in the case where a diffraction peak appears, the precipitated crystal can be identified by, for example, a three strong line method.

<Crystallized Glass>

The crystallized glass according to the present embodiment (hereinafter, also referred to as “the present crystallized glass”) is a crystallized glass including at least one crystal of indialite and cordierite, in which a total amount of the crystal is 40 mass % or more of the crystallized glass, and the crystal includes at least one of a vacancy and a different element at an Al site.

(Crystal)

The crystallized glass includes of at least one crystal of indialite and cordierite. Indialite and cordierite are MgO—Al₂O₃—SiO₂-based crystals having the same composition but different crystal structures. Compositions of these crystals are represented by chemical formula Mg₂Al₄Si₅O₁₈. When synthesized by a solid phase reaction method, cordierite is a low-temperature type and has a cubic crystal structure, whereas indialite is a high-temperature type and has a hexagonal crystal structure. Hereinafter, in the present specification, at least one crystal of indialite and cordierite included in the crystallized glass may be collectively referred to as “indialite/cordierite crystal”. That is, the “indialite/cordierite crystal” refers to one of the crystals in the case where the crystallized glass includes one of indialite and cordierite, and refers to both of the crystals in the case where the crystallized glass includes both indialite and cordierite.

An insulating substrate used in a high-frequency device is required to reduce transmission loss based on dielectric loss, conductor loss, and the like in order to ensure characteristics such as quality and strength of a high-frequency signal. In the crystallized glass including indialite/cordierite crystal, dielectric loss tangent and the relative dielectric constant tend to decrease as the ratio of crystal in the crystallized glass increases. In addition, in the indialite and the cordierite, the indialite tends to be more excellent in dielectric characteristics, and the crystallized glass preferably includes indialite.

From the viewpoint of obtaining crystallized glass having excellent dielectric characteristics, a total amount of indialite/cordierite crystal in the crystallized glass is 40 mass % or more of the crystallized glass. The total amount of the indialite/cordierite crystal is preferably 50 mass % or more, more preferably 55 mass % or more, and further preferably 60 mass % or more.

From the viewpoint of preventing cracking due to a difference in thermal expansion coefficient between a crystal phase and a glass phase, or from the viewpoint of ensuring a sufficient thermal expansion coefficient as crystallized glass, the total amount of indialite/cordierite crystal is preferably 90 mass % or less, more preferably 85 mass % or less, and further preferably 80 mass % or less of the crystallized glass.

Here, the indialite/cordierite crystal can be identified by X-ray diffraction measurement (XRD). Specifically, in the case where a bulk body of the crystallized glass is pulverized and measured by the XRD at 20=10° to 90° by using CuKα, ray, when a peak having largest intensity is confirmed in a range of 20=10° to 11° and the peak can be defined as a peak of a (100) plane, the crystallized glass includes at least one crystal of indialite and cordierite.

In order to obtain a more accurate crystal structure, it is preferable to perform Rietveld analysis. According to the Rietveld analysis, quantitative analysis of the crystal phase and the amorphous phase and structural analysis of the crystal phase can be performed. A Rietveld method is described in “Crystal Analysis Handbook” edited by “Crystal Analysis Handbook” Editorial Committee by the Crystallographic Society of Japan, (published by KYORITSU SHUPPAN CO., LTD., 1999, p492 to 499). A content of the indialite/cordierite crystal in the present crystallized glass can be calculated by Rietveld analysis using a measurement result obtained by the XRD.

In the present crystallized glass, the indialite/cordierite crystal includes at least one of the vacancy and the different element at the Al site. Here, the different element refers to an element other than Al. That is, the indialite/cordierite crystal of the present crystallized glass includes a portion in which no Al atom is present at a site that should be originally occupied by Al atom when an ideal crystal structure is repeated. In the case where no atom of different element is present in a portion in which no Al atom is present, the portion is a vacancy, and in the case where an atom of different element is present, the portion is a portion including the different element.

The different element is not particularly limited, but examples of the different element include element other than Al whose atomic size is relatively close to the size of the Al atom. Specific examples of such an element include Mg and Si.

In the case where the indialite/cordierite crystal includes at least one of the vacancy and the different element at the Al site, cracking of the crystallized glass due to the difference in thermal expansion coefficient between the crystal phase and the glass phase can be prevented. Since the indialite/cordierite crystal includes at least one of the vacancy and the different element at the Al site, the crystal structure is somewhat distorted compared to the ideal crystal structure, that is, a structure in which a lattice constant is elongated or shrunk only in a certain axial direction compared to an original lattice constant. Accordingly, it is considered that stress generated in the crystallized glass can be relaxed by the difference in thermal expansion coefficient between the crystal phase and the glass phase, and thus cracking can be prevented.

In addition, in the case where the indialite/cordierite crystal includes the vacancy at the Al site, the number of atoms in the crystal is smaller than that in the case of the ideal crystal structure. Here, it is known that the dielectric characteristics change according to the amount of electrons, and the dielectric constant tends to increase as the number of electrons increases. That is, presence of the vacancy at the Al site reduces the number of electrons compared to the case where the Al atom is present, and thus it is considered that the dielectric characteristics of the crystallized glass are more excellent.

From this, it is considered that, also in the case where the Al site includes the different element, when the number of electrons decreases as compared with the case where the Al atom is present, the dielectric characteristics are easily improved in the same manner. Therefore, from the viewpoint of further improving the dielectric characteristics, the number of electrons in the different element is preferably smaller than that in Al. Examples of such a different element include Mg.

in the indialite/cordierite crystal, the total of the portions including at least one of the vacancy and the different element at the Al site, that is, the total of the portions in which no Al atoms are present at the Al sites is preferably 4 atom % or more of the Al sites, from the viewpoint of improving the effect of preventing cracking. The total of the portions in which no Al atoms are present is more preferably 5 atom % or more, further preferably 7.5 atom % or more, even further preferably 9 atom % or more, particularly preferably 10 atom % or more, and still particularly preferably 12 atom % or more.

In addition, the total of portions in which no Al atoms are present at the Al sites is preferably 50 atom % or less, more preferably 35 atom % or less, and further preferably 20 atom % or less, from the viewpoint of maintaining the crystal structure.

The portions in which no Al atoms are present may be entirely vacancies, or may be entirely portions containing the different elements, but from the viewpoint of further increasing the effect of preventing the cracking and improving the dielectric characteristics, it is preferable that the vacancy be contained, and more preferable that the vacancies are more than the portion containing the different elements.

A ratio of the total of the portions in which the Al atoms are not present at the Al sites is an atomic fraction (atom %) of the portions in which no Al atoms are present with respect to the sites which should be originally occupied by the Al atoms when the ideal crystal structure is repeated. The ratio can be calculated by the Rietveld analysis using the measurement result obtained by the XRD.

The crystallized glass may include a crystal other than indialite/cordierite crystal as long as the effects of the present disclosure are not impaired. Examples of the crystal other than the indialite/cordierite crystal include mullite, corundum, rutile, and anatase. In the case where the crystal other than indialite/cordierite crystal is contained, the total content thereof is preferably 15 mass % or less, more preferably 12.5 mass % or less, and further preferably 10 mass % or less, with respect to the total amount of the crystallized glass. The identification of crystal species and the measurement of the content of the crystal other than the indialite/cordierite crystal can be performed by the Rietveld analysis using the XRD measurement and the XRD measurement result described above.

(Composition)

A composition of the present crystallized glass is the same as a composition of an amorphous glass before crystallization in a production method to be described later. Therefore, the preferable composition of the present crystallized glass and the composition of the amorphous glass are the same. Here, the composition of the crystallized glass in the present description refers to a total composition of the composition of the crystal phase and the glass phase of the crystallized glass. The composition of the crystallized glass is obtained by subjecting the crystallized glass to heat treatment at a temperature equal to or higher than a melting point to analyze the crystallized glass. An example of the analysis method is a fluorescent X-ray analysis method. The composition of the crystal phase of the present crystallized glass can be analyzed by the Rietveld analysis of the result obtained by the XRD measurement described above. In the composition of the present crystallized glass, a preferred lower limit of a content of a non-essential component is 0%.

The composition of the present crystallized glass is not particularly limited, and it is preferable to include 45% to 60% of SiO₂, 20% to 35% of Al₂O₃, and 9% to 15% of MgO in terms of mass percentage based on oxides. SiO₂, Al₂O₃, and MgO are components constituting the indialite/cordierite crystal.

SiO₂ is a component for precipitating the indialite/cordierite crystal as a crystal phase. The content of SiO₂ is preferably 45% or more. In the case where the content of SiO₂ is 45% or more, the precipitated crystal phase of the crystallized glass is easily stabilized. The content of SiO₂ is more preferably 45.2% or more, further preferably 45.5% or more, even further preferably 45.7% or more, particularly preferably 46% or more, even more preferably 46.2% or more, and most preferably 46.5% or more. The content of SiO₂ is preferably 60% or less. In the case where the content of SiO₂ is 60% or less, it is easy to melt or mold a glass raw material. In addition, as the crystal phase, a heat treatment condition is also an important factor in order to precipitate the indialite/cordierite crystal, and a wider range of the heat treatment condition can be selected by setting the content of SiO₂ to be equal to or less than the above upper limit. The content of SiO₂ is more preferably 58% or less, further preferably 56% or less, even further preferably 54% or less, particularly preferably 52% or less, even more preferably 50% or less, and most preferably 48% or less.

Al₂O₃ is a component for precipitating the indialite/cordierite crystal as a crystal phase. The content of Al₂O₃ is preferably 20% or more. In the case where the content of Al₂O₃ is 20% or more, a desired crystal phase is easily obtained, the precipitated crystal phase of the crystallized glass is easily stabilized, and an increase in a liquidus temperature can be reduced. The content of Al₂O₃ is more preferably 22% or more, further preferably 24% or more, even further preferably 26% or more, particularly preferably 28% or more, even more preferably 29% or more, and most preferably 30% or more. On the other hand, the content of Al₂O₃ is preferably 35% or less. In the case where the content of Al₂O₃ is 35% or less, meltability of the glass raw material tends to be good. The content of Al₂O₃ is more preferably 34.5% or less, further preferably 34% or less, even further preferably 33.5% or less, particularly preferably 33% or less, even more preferably 32.5% or less, and most preferably 32% or less.

MgO is a component for precipitating the indialite/cordierite crystal as a crystal phase. The content of MgO is preferably 9% or more. In the case where the content of MgO is 9% or more, a desired crystal is easily obtained, the precipitated crystal phase of the crystallized glass is easily stabilized, and meltability of the glass raw material is further improved. The content of MgO is more preferably 9.3% or more, further preferably 9.5% or more, even further preferably 9.7% or more, particularly preferably 10% or more, even more preferably 10.2% or more, and most preferably 10.5% or more. On the other hand, the content of MgO is preferably 15% or less. In the case where the content of MgO is 15% or less, a desired crystal is easily obtained. The content of MgO is more preferably 14.5% or less, further preferably 14% or less, even further preferably 13.5% or less, particularly preferably 13% or less, even more preferably 12.5% or less, and most preferably 12% or less.

The present crystallized glass preferably includes a nucleation component. The nucleation component is a component capable of generating a nucleus serving as a starting point of crystal growth when an amorphous glass is crystallized. By including the nucleation component, it is easier to stably obtain a desired crystal structure and a state in which the crystals are relatively homogeneously dispersed in the crystallized glass. Examples of the nucleation component include TiO₂, MoO₃, and ZrO₂. As the nucleation component, TiO₂ is preferable from the viewpoint of stably precipitating the indialite/cordierite crystal.

A total content of the nucleation components is preferably 5% or more, more preferably 5.5% or more, further preferably 6.0% or more, even further preferably 6.5% or more, particularly preferably 7.0% or more, even more preferably 7.5% or more, and most preferably 8.0% or more, from the viewpoint of allowing a nucleation agent to exist in the entire glass at a certain concentration or more. The total content of the nucleation components is preferably 15% or less, more preferably 14.5% or less, further preferably 14% or less, even further preferably 13.5% or less, particularly preferably 13% or less, even more preferably 12.5% or less, and most preferably 12% or less, from the viewpoint of increasing a ratio of the indialite/cordierite crystal in the entire crystallized glass and improving the dielectric characteristics.

TiO₂ is not an essential component, but is a component that functions as the nucleation component described above, and contributes to miniaturization of the precipitated crystal phase, improvement in mechanical strength of a material, and improvement in chemical durability. In the case where TiO₂ is included, the content thereof is preferably 5% or more, more preferably 5.5% or more, further preferably 6.0% or more, even further preferably 6.5% or more, particularly preferably 7.0% or more, even more preferably 7.5% or more, and most preferably 8.0% or more, from the viewpoint of stably precipitating the indialite/cordierite crystal. The content of TiO₂ is preferably 15% or less, more preferably 14.5% or less, further preferably 14% or less, even further preferably 13.5% or less, particularly preferably 13% or less, even more preferably 12.5% or less, and most preferably 12% or less, from the viewpoint of increasing a ratio of the indialite/cordierite crystal in the entire crystallized glass and improving the dielectric characteristics.

MoO₃ is not an essential component, but is a component that functions as the nucleation component described above. In the case where MoO₃ is included, the content thereof is preferably 5% or more, more preferably 5.5% or more, further preferably 6.0% or more, even further preferably 6.5% or more, particularly preferably 7.0% or more, even more preferably 7.5% or more, and most preferably 8.0% or more, from the viewpoint of stably precipitating the indialite/cordierite crystal. The content of MoO₃ is preferably 15% or less, more preferably 14.5% or less, further preferably 14% or less, even further preferably 13.5% or less, particularly preferably 13% or less, even more preferably 12.5% or less, and most preferably 12% or less, from the viewpoint of increasing a ratio of the indialite/cordierite crystal in the entire crystallized glass and improving the dielectric characteristics.

ZrO₂ is not an essential component, but is a component that functions as the nucleation component described above, and contributes to miniaturization of the precipitated crystal phase, improvement in mechanical strength of a material, and improvement in chemical durability. The content of ZrO₂ is preferably 5% or more, more preferably 5.5% or more, further preferably 6.0% or more, even further preferably 6.5% or more, particularly preferably 7.0% or more, even more preferably 7.5% or more, and most preferably 8.0% or more, from the view-point of stably precipitating the indialite/cordierite crystal. The content of ZrO₂ is preferably 15% or less, more preferably 14.5% or less, further preferably 14% or less, even further preferably 13.5% or less, particularly preferably 13% or less, even more preferably 12.5% or less, and most preferably 12% or less, from the viewpoint of increasing a ratio of the indialite/cordierite crystal in the entire crystallized glass and improving the dielectric characteristics.

The present crystallized glass preferably includes a vacancy-generating component. The vacancy-generating component refers to a component that makes it easy to form a portion in which no Al atom is present, that is, at least one of the vacancy and the portion containing the different element, at the Al site of the indialite/cordierite crystal. Examples of the vacancy-generating component include P₂O₅ and B₂O₃. Among these, P₂O₅ is a component that easily forms a large amount of vacancies and portions containing the different elements at the Al sites of the indialite/cordierite crystal, and is particularly preferable as the vacancy-generating component.

The reason why the vacancy or portion containing the different element is likely to be formed at the Al site by containing the vacancy-generating component is considered as follows. That is, the vacancy-generating component, for example, P₂O₅ causes minute phase separation during a crystallization process in which the amorphous glass is heated. When the indialite/cordierite crystals grow, since the crystals grows from each of such minute phase separation interfaces, dispersibility of the crystals in the crystallized glass is improved, and the crystals are more likely to be homogeneously formed. Accordingly, atoms around the Al site tend to compete for Al atoms during the crystal growth. Therefore, the Al site becomes a vacancy, and the different element such as Mg is likely to be incorporated. In the case where a portion in which no Al atom is present at the Al site is formed by the addition of the vacancy-generating component, it is considered that the portion tends to include the vacancy, and the vacancies are more likely to be more than the portion containing the different element.

The content of the vacancy-generating component is preferably 0.5% or more, more preferably 1% or more, further preferably 2% or more, and even further preferably 3% or more, from the viewpoint of facilitating formation of the portion in which no Al atom is present at the Al site. On the other hand, the content of the vacancy-generating component is preferably 15% or less, more preferably 7.5% or less, and further preferably 3.5% or less, from the viewpoint of preventing separation between the crystal phase and the glass phase, and from the viewpoint of stably precipitating the crystal.

P₂O₅ is not an essential component, but is preferably included because P₂O₅ functions as the vacancy-generating component described above. P₂O₅ also contributes to improvement in meltability, moldability, and devitrification resistance of the glass raw material in addition to a function as the vacancy-generating component. In the case where P₂O₅ is included, the content thereof is preferably 0.5% or more, more preferably 0.75% or more, further preferably 1% or more, even further preferably 1.25% or more, particularly preferably 1.5% or more, even more preferably 1.75% or more, and most preferably 2% or more, from the viewpoint of facilitating formation of the portion in which no Al atom is present at the Al site. The content of P₂O₅ is preferably 15% or less, more preferably 13% or less, further preferably 11% or less, even further preferably 9% or less, particularly preferably 7% or less, even more preferably 5% or less, and most preferably 3.5% or less, from the viewpoint of preventing separation between the crystal phase and the glass phase, and from the viewpoint of stably precipitating the crystal.

B₂O₃ is not an essential component, but may be included because B₂O₃ functions as the vacancy-generating component described above. B₂O₃ is a component that contributes to adjustment of viscosity during melting and molding of the glass raw material and also to a crystallization temperature. The content of B₂O₃ is preferably 0.5% or more, more preferably 0.75% or more, further preferably 1% or more, even further preferably 1.25% or more, particularly preferably 1.5% or more, even more preferably 1.75% or more, and most preferably 2% or more, from the viewpoint of facilitating formation of the portion in which no Al atom is present at the Al site. On the other hand, the content of B₂O₃ is preferably 10% or less, more preferably 9% or less, further preferably 8% or less, even further preferably 7% or less, particularly preferably 6% or less, even more preferably 5% or less, and most preferably 4% or less, from the viewpoint of preventing excessive decrease in the viscosity to be crystallized and stably producing the glass.

Further, in the case where both of P₂O₅ and B₂O₃ are added, a total amount is preferably 1% or more from the viewpoint of facilitating formation of the portion in which no Al atom is present at the Al site, and the total amount is preferably 15% or less from the viewpoint of preventing separation between the crystal phase and the glass phase and from the viewpoint of stably precipitating the crystal.

CaO may or may not be included, and 4% or less of CaO may be included because CaO has an action of improving the meltability of the glass raw material and at the same time preventing coarsening of the precipitated crystal phase. A more preferable range of the content of CaO is 1% or more. A more preferable range of the content of CaO is 3% or less.

BaO may or may not be included, and 5% or less of BaO may be included in order to improve the meltability of the glass raw material. A more preferable range of the content of BaO is 1% or more. A more preferable range of the content of BaO is 3% or less.

Sb₂O₃ and As₂O₃ may or may not be included, and 1% or less of Sb₂O₃ and As₂O₃ may be included because Sb₂O₃ and As₂O₃ act as a refining agent when the glass raw material is melted.

F may or may not be included, and 3% or less of F may be included in order to improve the meltability of the glass raw material.

SnO₂, CeO, and Fe₂O₃ may or may not be included, and a total amount of each of the components may be 5% or less in order to improve detection sensitivity of surface defects due to coloring or colorant of glass and to improve absorption characteristics of LD pumped solid-state laser.

(Physical Properties)

The dielectric loss tangent at 20° C. and 10 GHz of the present crystallized glass is preferably 0.003 or less, more preferably 0.002 or less, further preferably 0.0018 or less, even further preferably 0.0016 or less, particularly preferably 0.0014 or less, even more preferably 0.0012 or less, particularly preferably 0.001 or less, and most preferably 0.0008 or less, from the viewpoint of improving the dielectric characteristics. The dielectric loss tangent at 20° C. and 10 GHz is preferably as small as possible, and is usually 0.0001 or more.

The relative dielectric constant of the present crystallized glass at 20° C. and 10 GHz is preferably 7 or less, more preferably 6.5 or less, and further preferably 6 or less, from the viewpoint of improving the dielectric characteristics. The relative dielectric constant at 20° C. and 10 GHz is preferably as small as possible, and is usually 4.0 or more.

The present crystallized glass includes a relatively large amount of indialite/cordierite crystals, and thus has excellent dielectric characteristics. In the present crystallized glass, if the dielectric loss tangent or the relative dielectric constant at 20° C. and 10 GHz is within the above preferable ranges, it is considered that the dielectric characteristics for a band of a frequency higher than 10 GHz are also excellent. The dielectric characteristics such as the dielectric loss tangent and the relative dielectric constant are measured by a slip post dielectric resonance method (SPDR method).

Thermal conductivity of the present crystallized glass at 20° C. is preferably 1.0 W/(m K) or more, more preferably 1.5 W/(m·K) or more, further preferably 2.0 W/(m·K) or more, even further preferably 2.5 W/(m K) or more, and particularly preferably 3.0 W/(m K) or more, from the viewpoint of dissipating heat generated when the crystallized glass is used as a high-frequency substrate or the like with high efficiency. The thermal conductivity can be measured using a laser flash method thermophysical property measurement device in accordance with a method prescribed in JIS R1611 (2010). A higher thermal conductivity is more preferable, and it is usually 8.0 W/(m·K) or less. The thermal conductivity can be adjusted according to a crystal content, a crystal species, a crystal precipitation form, or the like. It is known that the thermal conductivity has a particularly high correlation with a crystallization ratio, and the thermal conductivity is generally 1.0 W/(m·K) or less in a glass that is not crystallized, whereas the thermal conductivity is improved in a sample after the crystallization.

An average thermal expansion coefficient of the present crystallized glass at 50° C. to 350° C. is preferably 1 ppm/° C. or more, more preferably 1.5 ppm/° C. or more, further preferably 1.75 ppm/° C. or more, particularly preferably 2.0 ppm° C. or more, even more preferably 2.25 ppm/° C. or more, and most preferably 2.5 ppm/° C. or more, from the viewpoint of reducing a difference in thermal expansion coefficient when the crystallized glass is used by adhering to another member or the like. In addition, the average thermal expansion coefficient at 50° C. to 350° C. is preferably 8.0 ppm/° C. or less, more preferably 7.0 ppm/° C. or less, and even more preferably 6.0 ppm/° C. or less, similarly from the viewpoint of reducing the difference in thermal expansion coefficient with another member, reducing the difference in thermal expansion coefficient between the crystal and the glass, and preventing cracking of the crystallized glass. The average thermal expansion coefficient at 50° C. to 350° C. can be measured using a differential thermal expansion meter in accordance with a method defined in JIS R3102 (1995). The average thermal expansion coefficient can be adjusted according to the glass composition, the crystal content, and the like. In addition, in the present crystallized glass, since the cracking due to the difference in thermal expansion coefficient between the crystal phase and the glass phase is prevented, it is easy to increase the average thermal expansion coefficient to some extent.

(Shape)

A shape of the present crystallized glass is not particularly limited, and various shapes can be made according to the purpose and application. For example, the present crystallized glass may have a sheet shape including two main surfaces facing each other, or may have a shape other than the sheet shape according to a product to be applied, the application, or the like. More specifically, the present crystallized glass may be, for example, a flat glass sheet having no warpage, or may be a curved glass sheet having a curved surface. The shape of the main surface is not particularly limited, and can be formed into various shapes such as a circular shape and a quadrangular shape.

Preferred examples of the shape of the present crystallized glass include a shape including two main surfaces facing each other, an area of the main surface of 100 cm² to 100000 cm², and a thickness of 0.01 mm to 2 mm.

The area of the main surface of the present crystallized glass is preferably 100 cm² or more, more preferably 225 cm² or more, and further preferably 400 cm² or more, from the viewpoint of transmission and reception efficiency when used in an antenna or the like. The area of the main surface is preferably 100000 cm² or less, more preferably 10000 cm² or less, and further preferably 3600 cm² or less, from the viewpoint of handleability.

The thickness of the present crystallized glass is preferably 0.01 mm or more, more preferably 0.05 mm or more, and further preferably 0.1 mm or more, from the viewpoint of maintaining the strength. The thickness of the present crystallized glass is preferably 2 mm or less, more preferably 1 mm or less, and further preferably 0.7 mm or less, from the viewpoint of improving production efficiency and from the viewpoint of thinning and miniaturizing parts and products using the crystallized glass.

(Applications)

The present crystallized glass is suitable for a circuit board such as a high-frequency device (electronic device) such as a semiconductor device used in a communication device such as a mobile phone, a smartphone, a mobile information terminal, or a Wi-Fi device, a surface acoustic wave (SAW) device, and a radar component such as a radar transceiver, or an antenna component such as a liquid crystal antenna. The present crystallized glass is particularly suitable for a high-frequency substrate or a liquid crystal antenna used in a high-frequency device, because the present crystallized glass has excellent dielectric characteristics particularly in a high-frequency range, prevents cracking due to a difference in thermal expansion coefficient between the crystal phase and the glass phase, and has excellent thermal shock resistance.

<High-frequency Substrate>

The present crystallized glass is excellent in dielectric characteristics at a high-frequency and is also excellent in thermal shock resistance, and thus can be used for a high-frequency substrate. A preferred range of a relative dielectric constant, a dielectric loss, a thermal conductivity, and an average thermal expansion coefficient of the high-frequency substrate according to the present embodiment (hereinafter, also referred to as the present high-frequency substrate) using the present crystallized glass is the same as that of the present crystallized glass.

The high-frequency substrate generally includes two main surfaces facing each other. An area of the main surface of the present high-frequency substrate is preferably 75 cm² or more, more preferably 100 cm² or more, further preferably 150 cm² or more, even further preferably 300 cm² or more, and particularly preferably 600 cm² or more, from the viewpoint of transmission and reception efficiency. The area of the main surface of the present high-frequency substrate is preferably 5000 cm² or less, from the viewpoint of ensuring the strength. The shape can be freely designed according to the application as long as the substrate has the area described above.

A sheet thickness of the present high-frequency substrate is preferably 1 mm or less, more preferably 0.8 mm or less, and further preferably 0.7 mm or less. In the case where the sheet thickness is within the above range, the entire thickness can be reduced when a circuit is formed by laminating the substrates, which is preferable. On the other hand, in the case where the sheet thickness is preferably 0.05 mm or more, and more preferably 0.2 mm or more, the strength can be ensured.

In the case where the present crystallized glass is used as a high-frequency substrate material, a hole may be formed in a crystallized glass substrate including the present crystallized glass. That is, the present high-frequency substrate may have a hole having an opening in at least one of the main surfaces. The hole may be a through hole communicating with the other main surface, or may be a non-penetrating void. In the case where these holes are filled with a conductor or a conductor film is formed on a hole wall, the present crystallized glass may be used as a circuit.

A diameter of the hole is, for example, 200 μm or less, preferably 100 μm or less, and more preferably 50 μm or less. On the other hand, the diameter of the hole is preferably 1 μm or more.

A method of forming the hole is not particularly limited, and, for example, a method of irradiating the crystallized glass substrate with a laser in order to form small holes having a diameter of 200 μm or less with high accuracy is preferable. The substrate using the present crystallized glass has excellent workability by laser irradiation. A wavelength of the laser is not particularly limited, and, for example, a wavelength of 10.6 μm or less, 3000 nm or less, 2050 nm or less, 1090 nm or less, 540 nm or 400 nm or less is used. In particular, in the case where small hole having a diameter of 100 μm or less are formed, the following two methods are preferable.

(Process by UV Laser)

A hole is formed in the crystallized glass substrate by emitting a UV laser having a wavelength of 400 nm or less. The UV laser is more preferably pulse-oscillated, and when laser irradiation is performed, an absorption layer is preferably disposed on the surface of the crystallized glass substrate. After the laser irradiation, the hole may be expanded by etching the crystallized glass substrate with a hydrofluoric acid-containing solution.

(Process by Forming Modified Portion)

A laser having a wavelength of 400 nm to 540 nm, for example, a wavelength of about 532 nm is emitted to form a modified portion on the crystallized glass substrate. Subsequently, the crystallized glass substrate is etched with the hydrofluoric acid-containing solution to selectively remove the modified portion to thereby form the hole. According to such a method, since the laser or the like is pulse-oscillated and the modified portion can be formed only by one shot of pulse irradiation, a hole formation speed is high and productivity is excellent.

<Liquid Crystal Antenna>

The liquid crystal antenna is a satellite communication antenna capable of controlling a direction of radio waves to be transmitted and received using a liquid crystal technology, and is suitably used mainly for a vehicle such as a ship, an airplane, an automobile, or the like. Since the liquid crystal antenna is mainly expected to be used outdoors, stable characteristics in a wide temperature range are required. In addition, resistance to thermal shock due to sudden temperature changes, such as between on the ground and in the sky, and due to squalls on scorching deserts, is also required.

The present crystallized glass is excellent in dielectric characteristics at a high-frequency and is also excellent in thermal shock resistance, and thus can be used for the liquid crystal antenna. A preferred range of a relative dielectric constant, a dielectric loss, a thermal conductivity, and an average thermal expansion coefficient of the liquid crystal antenna according to the present embodiment (hereinafter, also referred to as the present liquid crystal antenna) using the present crystallized glass is the same as that of the present crystallized glass.

The liquid crystal antenna generally includes two main surfaces facing each other. An area of the main surface of the liquid crystal antenna is preferably 75 cm² or more, more preferably 100 cm² or more, further preferably 150 cm² or more, even further preferably 300 cm² or more, and particularly preferably 700 cm² or more, from the viewpoint of transmission and reception efficiency. The area of the main surface of the liquid crystal antenna is preferably 10000 cm² or less, more preferably 3600 cm² or less, and further preferably 2500 cm² or less, from the viewpoint of handleability. The shape can be freely designed according to the application as long as the substrate has the area described above.

A sheet thickness of the present liquid crystal antenna is preferably 1 mm or less, more preferably 0.8 mm or less, and further preferably 0.7 mm or less. In the case where the sheet thickness is within the above range, the entire thickness can be reduced, which is preferable. On the other hand, in the case where the sheet thickness is preferably 0.05 mm or more, and more preferably 0.2 mm or more, the strength can be ensured.

<Method for Producing Crystallized Glass>

Next, a method for producing the present crystallized glass (hereinafter, also referred to as the present production method) will be described. The method for producing the present crystallized glass is not particularly limited, and is preferably, for example, the following method. Hereinafter, a method for producing a sheet-shaped glass will be described, and the shape of the glass can be appropriately adjusted according to the purpose.

The present production method includes preparing an amorphous glass including 45% to 60% of SiO₂, 20% to 35% of Al₂O₃, and 9% to 15% of MgO in terms of mass percentage based on oxides (amorphous glass molding step), and performing heat treatment on the amorphous glass (crystallization step). In addition, in the present production method, at least one crystal of indialite and cordierite is precipitated in the heat treatment, and at least one of the vacancy and the different element is made to be present at the Al site of the crystal.

Hereinafter, each step will be described in detail.

(Amorphous Glass Molding Step)

In this step, a raw material prepared so as to have a desired glass composition is melted and molded to thereby be an amorphous glass. The method of melting and molding is not particularly limited, and the glass raw material prepared by blending the glass raw material is put into a platinum crucible, put into an electric furnace at 1300° C. to 1700° C., melted, defoamed, and homogenized. The obtained molten glass is poured into a metal mold (for example, a stainless steel plate) at a room temperature, held at a temperature of a glass transition point for approximately 3 hours, and then cooled to the room temperature to thereby obtain a glass block of the amorphous glass. Further, the obtained glass block is subjected to process such as cutting, grinding, polishing, and the like as necessary to thereby mold the glass block into a desired shape. The cutting, grinding, polishing, and the like may be performed after the crystallization step. In the case where the amorphous glass is processed before the crystallization step, the shape thereof is not particularly limited, and the preferred shape is the same as the preferred shape of the present crystallized glass.

As described above, since the amorphous glass can be molded into a desired shape from a molten state, as compared with a process of molding a ceramic or the like with a powder or slurry and firing the resultant, or a process of manufacturing an ingot such as synthetic quartz and cutting the ingot into a desired shape, the amorphous glass has an advantageous in that it is easy to mold or increase the area, and can be manufactured at low cost in view of the crystallization step to be described later.

The amorphous glass preferably includes 45% to 60% of SiO₂. 20% to 35% of Al₂O₃, and 9% to 15% of MgO, from the viewpoint of precipitating at least one crystal of indialite and cordierite in the crystallized glass. The amorphous glass preferably includes 5% to 15% of TiO₂ as a nucleation agent. The amorphous glass preferably includes 0.5% to 15% of P₂O₅ as the vacancy-generating component. A preferred composition of the amorphous glass is the same as a preferred composition of the above-described crystallized glass in <crystallized glass>, and details thereof are the same as those described above.

(Crystallization Step)

Next, the amorphous glass obtained in the amorphous glass molding step is heat-treated.

In the heat treatment, the amorphous glass is preferably held at a specific treatment temperature for a specific holding time, and a treatment temperature and a holding time are not particularly limited as long as at least one crystal of indialite and cordierite is precipitated and at least one of the vacancy and the different element is made to be present at the Al site of the crystal.

In the present production method, at least one crystal of indialite and cordierite is precipitated in the heat treatment, and at least one of the vacancy and the different element is made to be present at the Al site of the crystal.

A method of allowing at least one of the vacancy and the different element to be present at the Al site is not particularly limited, and, for example, by containing the vacancy-generating component such as P₂O₅ in the composition and creating a minute phase-separated region in the glass in a first temperature range to be described later, it is easy to generate a portion in which no Al atom is present at the Al site. In addition, even when the temperature is rapidly increased during the heat treatment, a portion in which no Al atom is present at the Al site is easily generated. These methods may be used alone or in combination.

Specific preferred conditions of the heat treatment will be described below.

A treatment temperature is, for example, preferably 960° C. or higher, more preferably 980° C. or higher, and further preferably 1000° C. or higher, from the viewpoint of promoting precipitation of the indialite/cordierite crystal, shortening a heat treatment time, and improving productivity. On the other hand, the treatment temperature is preferably 1350° C. or lower, more preferably 1250° C. or lower, and further preferably 1150° C. or lower, from the viewpoint of preventing precipitation of crystal other than indialite/cordierite and from the viewpoint of productivity.

The holding time is preferably 0.5 hours or longer, more preferably 1 hour or longer, further preferably 1.5 hours or longer, even further preferably 2 hours or longer, particularly preferably 2.5 hours or longer, and most preferably 3 hours or longer. In the case where the holding time is within the above range, the crystallization sufficiently proceeds. On the other hand, since the heat treatment for a long time increases cost required for the heat treatment, the holding time is preferably 15 hours or less, more preferably 12 hours or less, and particularly preferably 10 hours or less.

The heat treatment preferably includes holding at the above treatment temperature, and may further include increasing and decreasing the temperature within the range of the above treatment temperature or within another temperature range.

Specifically, for example, the temperature may be increased from the room temperature to the first temperature range, held for a certain period of time, and then annealed to the room temperature, and a two-stage heat treatment may be selected in which the temperature is increased from the room temperature to the first temperature range and held for a certain period of time, then held for a certain period of time in a second temperature range that is higher than the first temperature range, and then annealed to the room temperature.

In particular, in the case where the composition includes the nucleation component or the vacancy-generating component, the heat treatment preferably includes the two-stage heat treatment including holding in the first temperature range and holding in the second temperature range. In the two-stage heat treatment, by holding in the first temperature range, a nucleus serving as a starting point of the growth of the indialite/cordierite crystal can be generated by the nucleation component in the amorphous glass. Then, by holding in the second temperature range, the indialite/cordierite crystal grows from the nucleus as the starting point. Even in the single-stage heat treatment, the indialite/cordierite crystal grows, but by growing a crystal after generating a nucleus, crystals are likely to be homogeneously present in the crystallized glass, making it easier to form portions in which no Al atoms are present at the Al sites. Further, in the case where the amorphous glass includes the vacancy-generating component, since the vacancy-generating component causes minute phase separation in the process of the heat treatment, crystal can be grown from an interface of such phase separation, making it easier to form portions in which no Al atoms are present at the Al sites.

In the case of the two-stage heat treatment, the first temperature range is preferably a temperature range in which a crystal nucleation rate increases in the glass composition. Specifically, the first temperature range is preferably 760° C. or higher, more preferably 800° C. or higher, and further preferably 850° C. or higher. The first temperature range is preferably 960° C. or lower, more preferably 920° C. or lower, and further preferably 880° C. or lower.

The holding time in the first temperature range is preferably 0.5 hours or longer, more preferably 1 hour or longer, further preferably 1.5 hours or longer, and particularly preferably 2 hours or longer. In the case where the holding time is within the above range, nucleation is likely to proceed sufficiently. On the other hand, the holding time is preferably 5 hours or less, more preferably 4 hours or less, and particularly preferably 3 hours or less, from the viewpoint of preventing the progress of crystal growth simultaneously with nucleation, and from the viewpoint of improving the dielectric characteristics of the entire crystallized glass.

The second temperature range is preferably a temperature range in which the crystal growth rate of the indialite/cordierite crystal increases. Specifically, the second temperature range is preferably 960° C. or higher, more preferably 980° C. or higher, and further preferably 1000° C. or higher. The second temperature range is preferably 1350° C. or lower, more preferably 1250° C. or lower, and further preferably 1150° C. or lower.

The holding time in the second temperature range is preferably 0.5 hours or more, more preferably 1 hour or longer, further preferably 1.5 hours or longer, even further preferably 2 hours or longer, particularly preferably 2.5 hours or longer, and most preferably 3.0 hours or longer. In the case where the holding time is within the above range, the crystal growth is likely to proceed sufficiently. On the other hand, the holding time is preferably 15 hours or less, more preferably 14 hours or less, and particularly preferably 12 hours or less, from the viewpoint of productivity.

A temperature-increasing rate in the heat treatment is not particularly limited, and is generally 5° C./min or more, and is preferably 15° C./min or more, more preferably 20° C./min or more, from the viewpoint of increasing the temperature-increasing rate and allowing at least one of the vacancy and the different element to be made to be present at the Al site.

On the other hand, in the case where the temperature-increasing rate is preferably 30° C./min or less, and more preferably 25° C./min or less, cracking due to the difference in thermal expansion coefficient between the glass phase and the crystal phase during temperature increase can be prevented.

A temperature-decreasing rate is not particularly limited, and in the case where the temperature-decreasing rate is preferably 10° C./min or less, more preferably 5° C./min or less, and further preferably 1° C./min or less, warpage of the crystallized glass when the temperature is decreased and cracking due to the difference in thermal expansion coefficient between the amorphous phase and the crystalline phase can be prevented. On the other hand, the temperature-decreasing rate is generally 0.5° C./min or more.

### EXAMPLE

Hereinafter, the present disclosure will be described in detail with reference to Examples, but the present disclosure is not limited thereto. Examples 1 to 8, 11 to 13, and 15 to 18 are working examples, and Examples 9, 10, and 14 are comparative examples.

Glass raw materials were prepared so as to have a composition shown in Table 1 in terms of a mole percentage based on oxides, and weighed out to give 400 g of glass. Then, the mixed raw materials were put in a platinum crucible, put into an electric furnace at 1500° C. to 1700° C., melted for about 3 hours, defoamed, and homogenized. In addition, Table 2 shows the components shown in Table 1 in terms of mass percentage.

The obtained molten glass was poured into a metal mold, held at a temperature of approximately 50° C. higher than a glass transition point for 1 hour, and then cooled to the room temperature at a rate of 0.5° C./min to thereby obtain a glass block. The obtained glass block was cut and ground, and finally mirror-polished on both surfaces to thereby obtain glasses 1 to 12 as glass sheet each having a size of 40 mm×40 mm and a thickness of 2 mm.

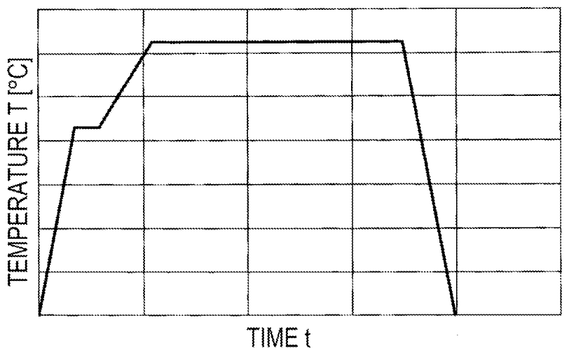

The obtained glass was subjected to a heat treatment as shown in the FIGURE. The FIG. 1s a diagram schematically showing a temperature change in a two-stage heat treatment. Specifically, the FIGURE shows that, in the heat treatment, the amorphous glass is heated to a temperature T1 at a first temperature-increasing rate, held for a holding time t1, then heated to a temperature T2 at a second temperature-increasing rate, held for a holding time t2, and then cooled.

Conditions such as a specific temperature of the heat treatment in the FIGURE were set to conditions shown in Table 3, and the heat treatment was performed to thereby obtain the crystallized glass. In addition, physical properties described in Table 3 were obtained from the obtained crystallized glass. In Table 3, blanks “-” in a “crystallization condition” column indicate that the heat treatment under the corresponding condition is not performed, and blanks “-” in a “characteristics” column indicate that a corresponding physical property is not measured.

Methods of measuring physical properties are shown below.

(XRD Measurement and Rietveld Analysis)

(Preparation Conditions of XRD Measurement Sample)

A crystallized glass sheet after the heat treatment was ground using an agate mortar and an agate pestle, thereby obtaining a powder for XRD measurement.

(XRD Measurement Conditions)

X-ray diffraction is measured under the following conditions, and a precipitated crystal is identified. For identification of crystal species, a diffraction peak pattern recorded in an ICSD inorganic crystal structure database and an ICDD powder diffraction database was used.

Measurement device: SmartLab manufactured by Rigaku Corporation

Measurement method: concentration method

Tube voltage: 45 kV

Tube current: 200 mA

X-ray to be used: CuKα ray

Measurement range: 20=10° to 80°

Speed: 10°/min

Step: 0.02°

(Preparation Conditions of Rietveld Measurement Sample)

After a crystallized glass powder used in the XRD measurement was passed through a mesh having an opening of 500 μm, ZnO was added as a standard substance so as to be 10 wt % of the entire sample.

(Rietveld Analysis Conditions)

The powder X-ray diffraction was measured under the following conditions, and the Rietveld analysis was performed using obtained results. Measurement device: SmartLab manufactured by Rigaku Corporation

Measurement method: concentration method

Tube voltage: 45 kV

Tube current: 200 mA

X-ray to be used: CuKα ray

Measurement range: 20=10° to 90°

Speed. 5°/min

Step: 0.01°

A powder X-ray diffraction profile obtained under the above conditions was analyzed using a Rietveld analysis program: Rietan FP. The analysis of each sample was converged so that Rwp representing quality of analysis convergence was 10 or less. A Rietveld method is described in “Crystal Analysis Handbook” edited by “Crystal Analysis Handbook” Editorial Committee by the Crystallographic Society of Japan, (published by KYORITSU SHUPPAN CO., LTD., 1999, p492 to 499).

(Calculation of Crystallization Ratio)

The content (crystallization ratio) of the indialite/cordierite crystal in the crystallized glass was calculated so that the added 10 wt % of ZnO was subtracted from a weight ratio of the crystal phase obtained from the Rietveld analysis and a weight ratio of the remaining glass phase obtained by subtracting the content of the crystal phase from the total amount of a measurement sample, and the total content was 100 wt % in the remaining phase. In Table 3 below, the “total amount of indialite/cordierite crystal” indicates the ratio (mass %) of the total content of indialite/cordierite crystals.

(Calculation of Porosity)

Using atomic occupancy of Al obtained from the Rietveld analysis, a porosity, that is, a ratio (atom %) of the total portions in which no Al atoms are present at the Al sites was calculated.

(Average Thermal Expansion Coefficient)

Measurement was performed using a differential thermal expansion meter in accordance with a method defined in JIS R3102 (1995). A measurement temperature range was 50° C. to 350° C., and the unit was represented as ppm/° C. As a sample, a sample obtained by processing the crystallized glass sheet after the heat treatment into a circular (cylindrical) shape having a diameter of 5 mm a thickness of 20 mm was used.

(Thermal Conductivity)

According to a method specified in JIS R1611 (2010), the thermal conductivity was measured using a laser flash method thermophysical property measurement device (LFA-502 manufactured by KYOTO ELECTRONICS MANUFACTURING CO., LTD). A measurement temperature was 20° C. As a sample, a sample obtained by processing the crystallized glass sheet after the heat treatment into a circular shape having a diameter of 5 mm×a thickness of 1 mm was used.

Relative Dielectric Constant ε′ and Dielectric Loss Tangent tanδ)

The obtained amorphous glass and crystallized glass were processed into a rectangular parallelepiped having a length of 30.0 mm, a width of 30.0 mm, and a thickness of 0.5 mm, and surfaces of 30.0 mm×30.0 mm were mirror-polished. Using a network analyzer, the relative dielectric constant ε′ and the dielectric loss tangent tanδ at 20° C. and 10 GHz were measured by a slip post dielectric resonance method (SPDR method).

(Sample State)

For each crystallized glass in Examples 1 to 18, ease of cracking of the sample was evaluated according to the following criteria by using five samples. In the case where the sample was visually checked and even a slightest cracking was found, it was determined that the sample was cracked.

A: The number of the samples having cracking after the heat treatment was one or less per five samples.

B: The number of the samples having cracking after the heat treatment was 2 to 3 per five samples.

C: The number of the samples having cracking after the heat treatment was four or more per five samples.

TABLE 1

| | Glass | Glass | Glass | Glass | Glass | Glass | Glass | Glass | Glass | Glass | Glass | Glass |
|---|---|---|---|---|---|---|---|---|---|---|---|---|
| (mol %) | 1 | 2 | 3 | 4 | 5 | 6 | 7 | 8 | 9 | 10 | 11 | 12 |
| SiO₂ | 51.3 | 51.3 | 51.3 | 52.3 | 56.0 | 51.3 | 52.8 | 52.3 | 51.3 | 54.5 | 52.9 | 52.4 |
| Al₂O₃ | 20.1 | 20.1 | 22.0 | 21.0 | 22.0 | 20.6 | 21.1 | 20.1 | 21.0 | 13.0 | 17.0 | 18.3 |
| B₂O₃ | 0.0 | 0.0 | 0.0 | 0.0 | 0.0 | 0.0 | 0.0 | 0.0 | 2.0 | 0.0 | 0.0 | 0.0 |
| P₂O₅ | 1.0 | 3.5 | 1.0 | 1.0 | 0.0 | 0.0 | 0.0 | 7.5 | 0.0 | 2.0 | 2.0 | 2.0 |
| MgO | 20.1 | 20.1 | 18.2 | 19.2 | 22.0 | 20.6 | 21.1 | 20.1 | 19.2 | 23.0 | 21.1 | 20.5 |
| TiO₂ | 7.5 | 5.0 | 7.5 | 6.5 | 0.0 | 7.5 | 5.0 | 0.0 | 6.5 | 7.5 | 7.0 | 6.8 |
| Sum | 100.0 | 100.0 | 100.0 | 100.0 | 100.0 | 100.0 | 100.0 | 100.0 | 100.0 | 100.0 | 100.0 | 100.0 |

TABLE 2

| | Glass | Glass | Glass | Glass | Glass | Glass | Glass | Glass | Glass | Glass | Glass | Glass |
|---|---|---|---|---|---|---|---|---|---|---|---|---|
| (wt %) | 1 | 2 | 3 | 4 | 5 | 6 | 7 | 8 | 9 | 10 | 11 | 12 |
| SiO₂ | 46.1 | 45.1 | 45.3 | 46.8 | 51.8 | 46.6 | 48.2 | 44.5 | 46.3 | 51.1 | 48.1 | 47.2 |
| Al₂O₃ | 30.7 | 30.0 | 33.0 | 31.9 | 34.5 | 31.8 | 32.7 | 29.0 | 32.2 | 20.7 | 26.2 | 28.0 |
| B₂O₃ | 0.0 | 0.0 | 0.0 | 0.0 | 0.0 | 0.0 | 0.0 | 0.0 | 2.1 | 0.0 | 0.0 | 0.0 |
| P₂O₅ | 2.1 | 7.3 | 2.1 | 2.1 | 0.0 | 0.0 | 0.0 | 15.1 | 0.0 | 4.4 | 4.3 | 4.3 |
| MgO | 12.1 | 11.8 | 10.8 | 11.5 | 13.7 | 12.6 | 12.9 | 11.5 | 11.6 | 14.5 | 12.9 | 12.4 |
| TiO₂ | 9.0 | 5.8 | 8.8 | 7.7 | 0.0 | 9.1 | 6.1 | 0.0 | 7.8 | 9.3 | 8.5 | 8.2 |
| Sum | 100.0 | 100.0 | 100.0 | 100.0 | 100.0 | 100.0 | 100.0 | 100.0 | 100.0 | 100.0 | 100.0 | 100.0 |

TABLE 3

| | Example | Example | Example | Example | Example | Example | Example | Example | Example |
|---|---|---|---|---|---|---|---|---|---|
| Crystallized glass | 1 | 2 | 3 | 4 | 5 | 6 | 7 | 8 | 9 |
| Starting glass | 1 | 2 | 3 | 3 | 4 | 4 | 4 | 4 | 4 |
| number | | | | | | | | | |

Crystallization conditions

| | | | | | | | | | |
|---|---|---|---|---|---|---|---|---|---|
| Temperature- | — | — | 5 | 5 | 5 | 5 | 5 | 5 | 5 |
| increasing rate to | | | | | | | | | |
| T1 [° C./min] | | | | | | | | | |
| Temperature T1 | — | — | 860 | 860 | 860 | 860 | 860 | 860 | 860 |
| [° C.] | | | | | | | | | |
| Holding time t1 | — | — | 2 | 2 | 2 | 2 | 2 | 2 | 2 |
| [h] | | | | | | | | | |
| Temperature- | 5 | 5 | 5 | 5 | 5 | 5 | 5 | 5 | 5 |
| increasing rate to | | | | | | | | | |
| T2 [° C./min] | | | | | | | | | |
| Temperature T2 | 1250 | 1056 | 1120 | 1250 | 1000 | 1060 | 1200 | 1300 | 900 |
| [° C.] | | | | | | | | | |
| Holding time t2 | 10 | 10 | 10 | 10 | 10 | 10 | 10 | 10 | 10 |
| [h] | | | | | | | | | |
| Sample state | A | A | A | A | A | A | A | A | A |

Characteristics

| Total amount of | 70% | 70% | 70% | 63% | 58% | 70% | 65% | 57% | 7% |
|---|---|---|---|---|---|---|---|---|---|
| indialite/cordierite | | | | | | | | | |
| crystal | | | | | | | | | |
| Porosity | 11% | 15% | 15% | 18% | 21% | 19% | 22% | 21% | — |
| Average thermal | 1.5 | 1.9 | 2.6 | 1.8 | — | 2.7 | 3.2 | — | — |
| expansion | | | | | | | | | |
| coefficient (50° C.- | | | | | | | | | |
| 350° C.) [ppm/° C.] | | | | | | | | | |
| Thermal | 3.4 | 2.0 | 3.5 | 3.9 | — | 2.6 | 3.5 | — | — |
| conductivity λ | | | | | | | | | |
| [W/(m · K)] | | | | | | | | | |
| ε′@20° C., 10 GHz | — | 5.7 | 6.7 | 7.0 | — | 6.0 | 6.5 | — | — |
| tanδ@20° C., | — | 0.0010 | 0.0005 | 0.0005 | — | 0.0010 | 0.0008 | — | — |
| 10 GHz | | | | | | | | | |
| | Example | Example | Example | Example | Example | Example | Example | Example | Example |
| Crystallized glass | 10 | 11 | 12 | 13 | 14 | 15 | 16 | 17 | 18 |
| Starting glass | 4 | 5 | 6 | 7 | 8 | 9 | 10 | 11 | 12 |
| number | | | | | | | | | |

Crystallization conditions

| | | | | | | | | | |
|---|---|---|---|---|---|---|---|---|---|
| Temperature- | 5 | — | — | 5 | 5 | 5 | 5 | 5 | 5 |
| increasing rate to | | | | | | | | | |
| T1 [° C./min] | | | | | | | | | |
| Temperature T1 | 860 | — | — | 860 | 860 | 860 | 840 | 860 | 860 |
| [° C.] | | | | | | | | | |
| Holding time t1 | 2 | — | — | 2 | 2 | 2 | 2 | 2 | 2 |
| [h] | | | | | | | | | |
| Temperature- | 5 | 20 | 25 | 20 | 5 | 5 | 5 | 5 | 5 |
| increasing rate to | | | | | | | | | |
| T2 [° C./min] | | | | | | | | | |
| Temperature T2 | 1060 | 1220 | 1150 | 1250 | 1250 | 1250 | 1200 | 1200 | 1200 |
| [° C.] | | | | | | | | | |
| Holding time t2 | 0.25 | 5 | 4 | 10 | 10 | 10 | 1 | 10 | 10 |
| [h] | | | | | | | | | |
| Sample state | A | B | B | B | C | B+ | A | A | A |

Characteristics

| | | | | | | | | | |
|---|---|---|---|---|---|---|---|---|---|
| Total amount of | 32% | 67% | 65% | 64% | 4% | 67% | 63% | 69% | 70% |
| indialite/cordierite | | | | | | | | | |
| crystal | | | | | | | | | |
| Porosity | — | 5% | 4% | 4% | — | 10% | 13% | 13% | 11% |
| Average thermal | — | — | 1.0 | — | — | — | 4.8 | — | — |
| expansion | | | | | | | | | |
| coefficient (50° C.- | | | | | | | | | |
| 350° C.) [ppm/° C.] | | | | | | | | | |
| Thermal | — | 3.6 | 3.8 | — | — | — | — | — | — |
| conductivity λ | | | | | | | | | |
| [W/(m · K)] | | | | | | | | | |
| ε′@20° C., 10 GHz | — | 4.7 | 5.6 | — | — | — | 5.9 | 6.4 | 6.3 |
| tanδ@20° C., | — | 0.0010 | 0.0003 | — | — | — | 0.0009 | 0.0007 | 0.0010 |
| 10 GHz | | | | | | | | | |

The crystallized glasses in Examples 1 to 8, 11 to 13, and 15 to 18, which are working examples, which were obtained by using the glasses 1 to 7 and 9 to 12, did not break the samples after the heat treatment or were less likely to crack the samples, and further, the physical properties of the sample could be measured after processing the sample, and the content of the indialite/cordierite crystal was 40 mass % or more. The crystallized glass in Example 15 was less likely to crack than the crystallized glasses in Examples 11 to 13. Therefore, in Table 3, the sample state of Example 15 was defined as B+.

In the crystallized glasses in Examples 2 to 4, 6, 7, and 12, the content of the indialite/cordierite crystal was 40 mass % or more, an average thermal expansion coefficient at 50° C. to 350° C. was 1 ppm or more, and the thermal conductivity at 20° C. was 1.0 W/(m·K) or more.

Further, it was confirmed that the crystallized glasses in Examples 2, 3, 4, 6, 7, 11, 12, 16, 17, and 18, which are working examples, had good values of a relative dielectric constant at 20° C. and 10 GHz of 7 or less and a dielectric loss tangent 20° C. and 10 GHz of 0.003 or less, and had good radio wave permeability.

On the other hand, in the crystallized glass in Example 9, since the temperature of the heat treatment was low, sufficient crystallization did not occur, and the crystallization ratio was low. With respect to the crystallized glass in Example 10, since the time of the heat treatment was short, sufficient crystallization did not occur, and the crystallization ratio was low. As for Example 14, a crystal precipitation amount of indialite/cordierite crystal was reduced because a ratio of P was too high. In addition, in the crystallized glass in Example 14, a large amount of crystals other than the indialite/cordierite crystal were precipitated, and the sample was easily cracked after the heat treatment.

Although the present disclosure has been described in detail with reference to specific embodiments, it is apparent to those skilled in the art that various changes and modifications can be made without departing from the spirit and scope of the present disclosure. The present application is based on a Japanese Patent Application (No. 2020-157712) filed on Sep. 18, 2020, the contents of which are incorporated herein by reference.

### INDUSTRIAL APPLICABILITY

The crystallized glass according to the present disclosure is excellent in dielectric characteristics of high-frequency signals and exhibits high thermal shock resistance.

Such a crystallized glass is very useful as a member of general high-frequency electronic devices such as high-frequency substrates that handle high-frequency signals exceeding 10 GHz, particularly high-frequency signals exceeding 30 GHz, and further high-frequency signals exceeding 35 GHz, liquid crystal antennas used in an environment where a temperature change is large, devices involving drilling by laser, or the like.

1. A crystallized glass comprising:
at least one crystal of indialite and cordierite, wherein
the crystallized glass has a total amount of the crystal is 40 mass % or more of the crystallized glass, and
the crystal comprises at least one of a vacancy and a different element at an Al site.

2. The crystallized glass according to claim 1, wherein a total of portions containing at least one of the vacancy and the different element is 4 atom % or more of the Al sites.

3. The crystallized glass according to claim 1, further comprising:
in terms of mass percentage based on oxides,
45% to 60% of SiO₂;
20% to 35% of Al₂O₃; and
9% to 15% of MgO.

4. The crystallized glass according to claim 3, further comprising:
5% to 15% of TiO₂ in terms of mass percentage based on oxides.

5. The crystallized glass according to claim 3, further comprising:
0.5% to 15% of P₂O₅ in terms of mass percentage based on oxides.

6. The crystallized glass according to claim 1, wherein the crystallized glass comprises main surfaces facing each other, the main surface has an area of 100 cm² to 100000 cm², and the crystallized glass has a thickness of 0.01 mm to 2 mm.

7. The crystallized glass according to claim 1, wherein the crystallized glass has a thermal conductivity at 20° C. of 1.0 W/(m K) or more.

8. The crystallized glass according to claim 1, wherein the crystallized glass has a relative dielectric constant at 20° C. and 10 GHz of 7 or less.

9. The crystallized glass according to claim 1, wherein the crystallized glass has a dielectric loss tangent at 20° C. and 10 GHz of 0.003 or less.

10. The crystallized glass according to claim 1, wherein the crystallized glass has an average thermal expansion coefficient at 50° C. to 350° C. of 1 ppm/° C. or more.

11. A high-frequency substrate using the crystallized glass according to claim 1.

12. A liquid crystal antenna using the crystallized glass according to claim 1.

13. An amorphous glass comprising:
in terms of mass percentage based on oxides,
45% to 60% of SiO₂;
20% to 35% of Al₂O₃;
9% to 15% of MgO;
0.5% to 15% of P₂O₅; and
5% to 15% of TiO₂.

14. A method for producing a crystallized glass, the method comprising:
preparing an amorphous glass comprising, in terms of mass percentage based on oxides,
45% to 60% of SiO₂,
20% to 35% of Al₂O₃, and
9% to 15% of MgO: and
performing heat treatment on the amorphous glass, wherein
in the heat treatment, at least one crystal of indialite and cordierite is precipitated, and at least one of a vacancy and a different element is made to be present at an Al site of the crystal.

15. The method for producing a crystallized glass according to claim 14, wherein
the amorphous glass comprises,
in terms of mass percentage based on oxides,
0.5% to 15% of P₂O₅, and
5% to 15% of TiO₂.

16. The method for producing a crystallized glass according to claim 14, wherein the amorphous glass comprises main surfaces facing each other, the main surface has an area of 100 cm² to 100000 cm², and the amorphous glass has a thickness of 0.01 mm to 2 mm.

17. The method for producing a crystallized glass according to claim 14, wherein the heat treatment comprises holding the amorphous glass at 960° C. or higher for 0.5 hours or longer.

18. The method for producing a crystallized glass according to claim 14, wherein the heat treatment comprises holding in a first temperature range and holding in a second temperature range, the first temperature range is 760° C. or higher and 960° C. or lower, and a holding time in the first temperature range is 0.5 hours or longer, and
the second temperature range is 960° C. or higher and 1350° C. or lower, and a holding time in the second temperature range is 0.5 hours or longer.
